(19) United States
(12) Patent Application Publication
(10) Pub. No.: US 2020/0042512 A1
(43) Pub. Date: Feb. 6, 2020

(54) EMBEDDING DATABASE PRIMITIVES INTO DISTRIBUTED LEDGERS

(71) Applicant: Stephen Young, Sydney (AU)

(72) Inventor: Stephen Young, Sydney (AU)

(21) Appl. No.: 15/974,020

(22) Filed: May 8, 2018

(51) Int. Cl. G06F 16/23; G06F 16/27

(52) U.S. Cl. CPC G06F 16/2379; G06F 16/27

(57) ABSTRACT

A method is provided. The method comprises a computer embedding a first database primitive in a first entry of a distributed ledger. The method also comprises the computer embedding a second database primitive in a second entry of the distributed ledger. The method also comprises the computer extracting at least one of the first and second database primitives from the distributed ledger.

### CROSS REFERENCE TO RELATED APPLICATIONS

None.

### FIELD OF THE DISCLOSURE

The present disclosure relates generally to managing primitives for insertion into databases. More particularly, the present disclosure provides systems and methods of embedding primitives into distributed ledgers to assist tracking and support integrity as well as observe entries of primitives at distributed ledger for later extraction and use in building and rebuilding databases.

### BACKGROUND OF THE DISCLOSURE

Integrity of data is the maintenance of, and the assurance of the accuracy and consistency of, data. Integrity is a critical aspect to the design, implementation and usage of any system which stores, processes, or retrieves data. The overall intent of any data integrity technique is the same: ensure data is recorded exactly as intended (such as a database correctly rejecting mutually exclusive possibilities,) and upon later retrieval, ensure the data is the same as it was when it was originally recorded. Data integrity aims to prevent unintentional or malicious changes to information. Logical integrity is concerned with the correctness or rationality of a piece of data, given a particular context. This includes topics such as referential integrity and entity integrity in a relational database. Data integrity often includes checks and correction for invalid data, based on a fixed schema or a predefined set of rules. Continuous availability and geographical accessibility of data are desirable properties of a database. A distributed ledger may feed any number of instances of a database and the instances may be geographically separated thereby making the database more available. Earthquakes, fires, terrorist attacks and other disasters threaten the continuous availability of a database. A distributed ledger is by its nature resistant to such disasters. Distributed ledgers may allow for decentralized curation and administration. A distributed ledger may be managed cooperatively and by consensus, making stored data resistant to the phenomenon of alternative truths.

### SUMMARY OF THE DISCLOSURE

In an embodiment a method is provided. The method comprises a computer embedding a first database primitive in a first entry of a distributed ledger. The method also comprises the computer embedding a second database primitive in a second entry of the distributed ledger. The method also comprises the computer extracting at least one of the first and second database primitives from the distributed ledger.

In an embodiment a system is provided. The system comprises a processor and a memory. The system also comprises an application stored in the memory that when executed on the processor embeds a first database primitive in a first entry of a distributed ledger. The system also embeds a second database primitive in a second entry of the distributed ledger, and extracts at least one of the first and second database primitives from the distributed ledger.

In an embodiment, a method is provided. The method comprises a computer monitoring activity associated with a distributed ledger for appearance of new database primitives. The method also comprises the computer determining that at least one newly appeared database primitive is associated with a first database. The method also comprises the computer updating the first database based on the appearance of the at least one newly appeared database primitive.

### BRIEF DESCRIPTION OF THE DRAWINGS

FIG. 1 depicts a block diagram of embedding database primitives into distributed ledgers according to an embodiment of the present disclosure.

FIG. 2 depicts a flowchart of a method of embedding database primitives into distributed ledgers according to an embodiment of the present disclosure.

FIG. 3 depicts a flowchart of a method of embedding database primitives into distributed ledgers according to an embodiment of the present disclosure.

### DETAILED DESCRIPTION OF THE INVENTION

Systems and methods are provided herein for an application to embed database primitives in a distributed ledger. The application and associated components may later extract the primitives from the distributed ledger to build a new database or update a functioning database. The application may also use the stored primitives to rebuild a damaged, corrupt or otherwise compromised database.

By storing the primitives in a distributed ledger, for example a blockchain, integrity of the primitives is strongly supported based on the safeguards and protections inherent to distributed ledgers. Entries of primitives and associated material into a distributed ledger may be checked against other entries. Verification and cross-checking functionality built into the distributed ledger reinforce integrity of primitives and other data.

The present disclosure also provides for the application to observe activity of the distributed ledger associated with incoming primitives. While the application itself may be a party to receiving and storing primitives into a distributed ledger, the application may also function in an observation capacity, monitoring the ledger for receipt and entry of primitives into the ledger by other components that my be unrelated to the application. Upon observing that the distributed ledger has received and stored a primitive, the application may identify the sources of the primitive and ultimate database destination(s) of the primitive. The application may immediately or subsequently extract the primitive, cause ledger verification of the primitive to be performed again or for the first time, and use the primitive to modify, build, rebuild, or repair a database.

The application, in receiving and storing primitives as well as in observing ledger activity and noting that a particular ledger is receiving and storing primitives independent of the application, identifies the sources of the primitives and determines destination database(s) for the primitives when this information is available. The application may determine to which database a stored primitive ultimately belongs when more than one database is involved. The application may additionally or alternatively receive and execute instructions from a separate component on when to extract a primitive from a distributed ledger and to which database the primitive should be inserted.

When a task is presently at hand, such as a database being built or rebuilt, the application may assist in such tasks or may cause other components to do so. The application may determine from which distributed ledger to extract primitives for a task when more than one such ledger is present and monitored by the application.

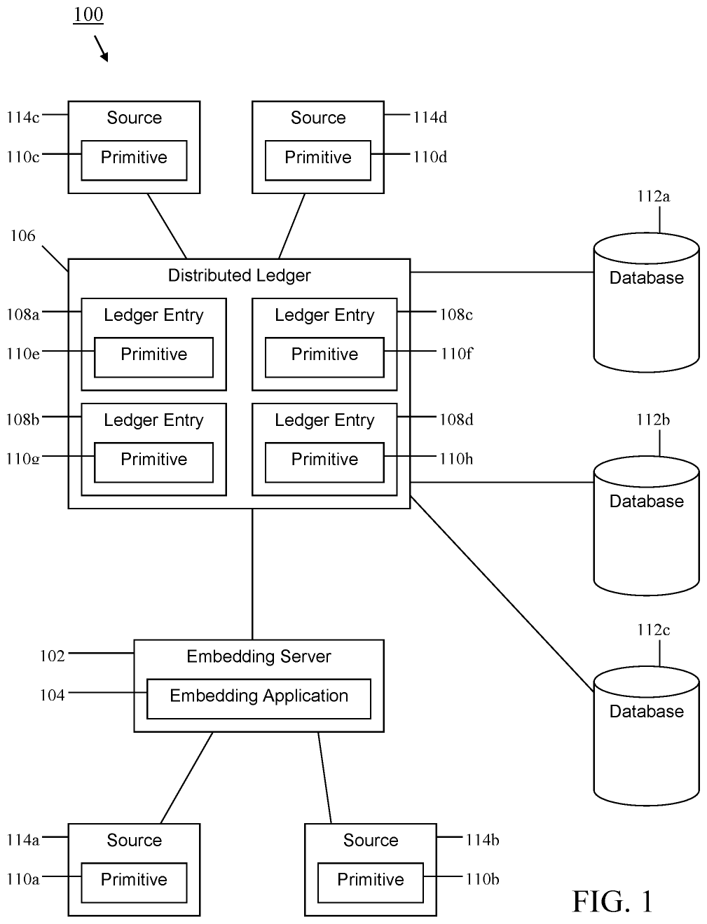

Turning to the figures, FIG. 1 is a block diagram of a system of embedding primitives into distributed ledgers according to an embodiment of the present disclosure. FIG. 1 depicts components of a system 100.

The system 100 comprises an embedding server 102, an embedding application 104, and a distributed ledger 106. These components may be referred to herein for brevity purposes as the server 102, the application 104, and the ledger 106, respectively.

The system 100 also comprises ledger entries 108a, 108b, 108c, 108d and primitives 110a, 110b, 110c, 110d, 110e, 110f, 110g, 110h. The assignment of letters to these components is arbitrary and for discussion and illustration purposes. The system 100 also comprises databases 112a, 112b, 112c and sources 114a, 114b, 114c, with the letter designations provided arbitrarily as above.

The server 102 and the application 104 receive primitives 110a and 110b from sources 114a and 114b and store the primitives 110a-b in the distributed ledger 106 where the primitives 110a-b become two of primitives 110a-d. As noted, lettering of components is arbitrary.

The primitives 110a-b are stored in the distributed ledger 106 using two of ledger entries 108a-d. Creation and execution of the ledger entries 108a-d may be completed by the application 104 or by other components. Integrity checking of ledger entries 108a-d may be completed by the application 104 or by other components.

Primitives are stored in the distributed ledger 106 by the application 104 when received by the application 104 from sources 114a-b. But, as noted, primitives 110c-d may also be received and stored by the distributed ledger 106 independent of the application 104. In its additional capacity of monitoring activities of the distributed ledger 106, the application 104 observes and is aware of instances of the distributed ledger 106 receiving primitives 110c-d from sources 114c-d, activity that is unrelated to the server 102 and application 104 and merely observed and noted by the application 104.

Whether directly receiving and storing primitives 110a-b or merely observing the distributed ledger 106 receiving primitives 110c-d from other sources 114c-d unrelated to the application 104, the application 104 remains aware of stored primitives 110a-d that remain in the distributed ledger 106. At times when stored primitives 110a-d are needed to modify, build, rebuild, or update one of the databases 112a, 112b, 112c, the application 104 extracts the needed at least one stored primitive 110a-d and completes the needed action or involves the necessary component for the action.

In embodiments, more than one distributed ledger 106 may be in effect. Primitives 110a-h may be sent to and assembled from more than one distributed ledger 106. Similarly, more than one embedding application 104 and more than one server 102 may be in effect. Two or more instances of the embedding application 104 may execute on a single server 102 or on multiple servers 102. The more than one embedding application 104 may simultaneously or separately extract primitives 110e-h to build, rebuild, or update databases 112a-c as discussed herein. In embodiments, a first embedding application 104 may embed primitives 110a-h and a separate and unrelated second embedding application 104 may later extract primitives 110a-h for various purposes described herein. Further, multiple primitives 110a-h may be contained within a single ledger entry 108a-d and embedded into the distributed ledger 106.

The application 104 may determine that at least one newly appeared ledger entry is associated with a first database and may determine that at least one newly appeared database primitive is associated with the first database. The application 104 may further determine that at least one property of a newly appeared ledger entry associates the entry with the first database and may also determine that at least one property of a newly appeared database primitive associates the primitive with the first database.

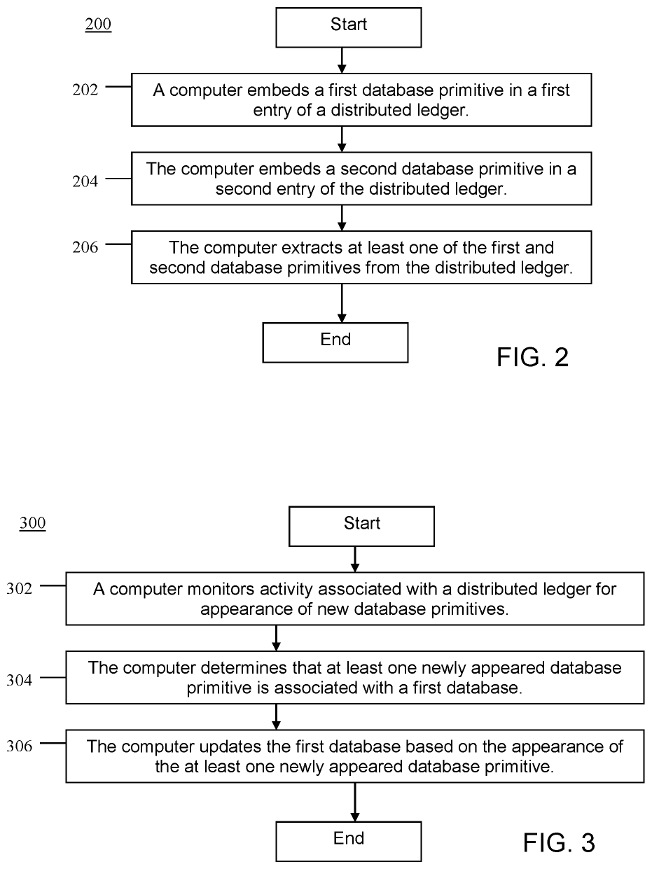

FIG. 2 depicts a flowchart of a method 200 of embedding database primitives into distributed ledgers according to an embodiment of the present disclosure. The method 200 uses the components of the system 100. Beginning at block 202, a computer embeds a first database primitive in a first entry of a distributed ledger. At block 204, the computer embeds a second database primitive in a second entry of the distributed ledger. At block 206, the computer extracts at least one of the first and second database primitives from the distributed ledger. The method 200 thereafter ends.

FIG. 3 depicts a flowchart of a method 300 of embedding database primitives into distributed ledgers according to an embodiment of the present disclosure. The method 300 uses the components of the system 100. Beginning at block 302, a computer monitors activity associated with a distributed ledger for appearance of new database primitives. At block 304, the computer determines that at least one newly appeared database primitive is associated with a first database. At block 306, the computer updates the first database based on the appearance of the at least one newly appeared database primitive. The method 300 thereafter ends.

1. A method, comprising:
a computer embedding a first database primitive in a first entry of a distributed ledger;
the computer embedding a second database primitive in a second entry of the distributed ledger;
the computer extracting at least one of the first and second database primitives from the distributed ledger.

2. The method of claim 1, further comprising the computer extracting at least one of the first and the second database primitive from the distributed ledger to at least one of build a database and rebuild a previously built database.

3. The method of claim 1, wherein addressing in the distributed ledger of the first entry and contents of the first database primitive are obtainable via accessing the second entry and wherein addressing in the distributed ledger of the second entry and contents of the second database primitive are obtainable via accessing the first entry.

4. The method of claim 1, further comprising the computer monitoring activity associated with the distributed ledger for appearance of new database primitives

5. The method of claim 1, further comprising the computer determining that at least one newly appeared ledger entry is associated with a first database.

6. The method of claim 5, further comprising the computer determining that at least one newly appeared database primitive is associated with the first database.

7. The method of claim 5, further comprising the computer determining that at least one property of a newly appeared ledger entry associates the entry with the first database.

8. The method of claim 5, further comprising the computer determining that at least one property of a newly appeared database primitive associates the primitive with the first database.

9. The method of claim 5, further comprising the computer updating the first database based on the appearance of at least one new database primitive.

10. A system, comprising:
a processor;
a memory;
an application stored in the memory that when executed on the processor:
embeds a first database primitive in a first entry of a distributed ledger,
embeds a second database primitive in a second entry of the distributed ledger, and
extracts at least one of the first and second database primitives from the distributed ledger.

11. The system of claim 10, wherein the application extracts at least one of the first and the second database primitive from the distributed ledger to build a database.

12. The system of claim 10, wherein addressing in the distributed ledger of the first entry and contents of the first database primitive are obtainable via accessing the second entry and wherein addressing in the distributed ledger of the second entry and contents of the second database primitive are obtainable via accessing the first entry.

13. The system of claim 10, wherein the application extracts at least one of the first and second database primitives from the distributed ledger to rebuild a previously built database.

14. The system of claim 10, wherein the distributed ledger is a blockchain.

15. A method, comprising:
a computer monitoring activity associated with a distributed ledger for appearance of new database primitives;
the computer determining that at least one newly appeared database primitive is associated with a first database; and
the computer updating the first database based on the appearance of the at least one newly appeared database primitive.

16. The method of claim 15, further comprising the computer alternatively building a new database using the at least one newly appeared database primitive.

17. The method of claim 15, further comprising database primitives comprising at least one of a database transaction, an RDF triple, a tuple, and a row in a table.

18. The method of claim 15, wherein the distributed ledger is a blockchain.

19. The method of claim 15, further comprising the computer inserting multiple database transactions inside each of many ledger transactions.

20. The method of claim 19, further comprising the computer assembling a general purpose database by reading the each of many ledger transactions
